(19) United States
(12) Patent Application Publication
(10) Pub. No.: US 2024/0141898 A1
(43) Pub. Date: May 2, 2024

(54) FLUID MACHINE

(71) Applicant: KABUSHIKI KAISHA TOYOTA JIDOSHOKKI, Kariya-shi (JP)

(72) Inventors: Fumiya SHINODA, Kariya-shi (JP); Fumihiro Suzuki, Kariya-shi (JP)

(73) Assignee: KABUSHIKI KAISHA TOYOTA JIDOSHOKKI, Kariya-shi (JP)

(21) Appl. No.: 18/242,853

(22) Filed: Sep. 6, 2023

(30) Foreign Application Priority Data
Oct. 27, 2022 (JP) 2022-172468

(51) Int. Cl. F04C 29/04; F04C 29/02; F16C 32/06; F16C 37/00

(52) U.S. Cl. CPC F04C 29/04; F04C 29/02; F16C 32/0629; F16C 37/002

(57) ABSTRACT

A fluid machine includes a plurality of fluid dynamic plain bearings supporting a rotating member. The fluid dynamic plain bearings each include: a top foil; a bump foil; and a bearing housing. The top foil has a bearing surface that has one end portion and the other end portion in a circumferential direction of the bearing surface. The top foil has a fixed end and a free end respectively formed at the one end portion and the other end portion. A movement of the free end in an axial direction of the rotating member is regulated by a regulating member. A clearance through which a fluid flows is formed between the fixed end and the free end. The free end has a discharge passage through which a foreign substance contained in the fluid is discharged from the clearance. The discharge passage is formed through the free end.

### CROSS-REFERENCE TO RELATED APPLICATION

This application claims priority to Japanese Patent Application No. 2022-172468 filed on Oct. 27, 2022, the entire disclosure of which is incorporated herein by reference.

The present disclosure relates to a fluid machine.

### BACKGROUND ART

Japanese Patent Application Publication No. 2022-057207 mentions a known fluid machine that includes an operating member, a rotating member, a housing, and a plurality of fluid dynamic plain bearings, for example. The rotating member is configured to rotate to drive the operating member. The housing accommodates the operating member and the rotating member. The plurality of fluid dynamic plain bearings supports the rotating member such that the rotating member is rotatable relative to the housing.

Such a fluid machine may include a cooling flow passage in which a fluid for directly cooling the fluid dynamic plain bearings flows. The cooling flow passage is formed in the housing. The fluid flowing in the cooling flow passage flows through a gap between the rotating member and the fluid dynamic plain bearings.

The fluid dynamic plain bearings each include a top foil, a bump foil, and a bearing housing. The top foil faces the rotating member. The top foil has a bearing surface that has a cylindrical shape. The bump foil has a thin plate shape. The bump foil is arranged on the opposite side of the top foil from the rotating member. This bump foil is configured to extend to elastically support the top foil. The bearing housing supports the top foil and the bump foil.

The bearing surface has one end portion in the circumferential direction of the bearing surface, and the top foil has a fixed end formed at the one end portion of the bearing surface. The fixed end extends to and is fixed to the bearing housing. The bearing surface has the other end portion in the circumferential direction of the bearing surface, and the top foil has a free end formed at the other end portion of the bearing surface.

The top foil of such a fluid machine may become deformed, like twisted, unless a regulating member, such as a holding member mentioned in Japanese Patent Application Publication No. 2022-057207, regulates the movement of the free end in the axial direction of the rotating member. In this case, the rotating member may come in contact with the inner surface of the cylindrical portion of the top foil, so that the rotating member and the top foil may be worn unevenly.

However, the free end extends toward the bearing housing and faces the regulating member in the axial direction of the bearing housing so that the movement of the free end in the axial direction of the rotating member is regulated by the regulating member. This configuration suppresses deformation of the top foil, thereby reducing uneven wear of the rotating member and the top foil.

However, the fluid flowing in the cooling flow passage flows through a clearance between the fixed end and the free end. This allows a foreign substance, such as abrasion powders or dusts produced by a contact between the rotating member and the top foil, to flow into the clearance between the fixed end and the free end, for example. The foreign substance is deposited in the clearance between the fixed end and the free end, so that the deposited foreign substance may decrease the durability of the fluid dynamic plain bearing.

The present disclosure, which has been made in light of the above described problem, is directed to providing a fluid machine that is capable of reducing deposition of a foreign substance flowing into a clearance between a fixed end and a free end and therefore curbing a decline in the durability of a fluid dynamic plain bearing.

### SUMMARY

In accordance with an aspect of the present disclosure, there is provided a fluid machine that includes an operating member; a rotating member configured to rotate to drive the operating member; a housing for accommodating the operating member and the rotating member; a plurality of fluid dynamic plain bearings supporting the rotating member such that the rotating member is rotatable relative to the housing; and a cooling flow passage which is formed in the housing and in which a fluid flows through a gap between the rotating member and the fluid dynamic plain bearings to directly cool the fluid dynamic plain bearings. The fluid dynamic plain bearings each include: a top foil; a bump foil; and a bearing housing. The top foil faces the rotating member, and has a bearing surface that has a cylindrical shape and one end portion and the other end portion in a circumferential direction of the bearing surface. The bump foil has a thin plate shape, and the bump foil is arranged on the opposite side of the top foil from the rotating member, and configured to extend to elastically support the top foil. The bearing housing supports the top foil and the bump foil. The top foil has a fixed end and a free end respectively formed at the one end portion and the other end portion of the bearing surface of the top foil. The fixed end extends toward and is held by the bearing housing. The free end extends toward the bearing housing. A movement of the free end of the top foil in an axial direction of the rotating member is regulated by a regulating member. A clearance through which the fluid flows is formed between the fixed end and the free end. The free end has a discharge passage through which a foreign substance contained in the fluid is discharged from the clearance. The discharge passage is formed through the free end.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a schematic configuration diagram of a fluid machine to which a fluid dynamic plain bearing is mounted;

FIG. 2 is a sectional view of the fluid dynamic plain bearing and a rotating member;

FIG. 3 is an exploded perspective view of the fluid dynamic plain bearing;

FIG. 4 is a perspective view of a discharge passage formed in a top foil according to a first embodiment;

FIG. 5 is a perspective view of a discharge passage formed in a top foil according to a second embodiment;

FIG. 6 is a sectional view of a fluid dynamic plain bearing and a rotating member according to a third embodiment;

FIG. 7 is a perspective view of a discharge passage formed in a top foil according to a modification; and

FIG. 8 is a perspective view of a discharge passage formed in a top foil according to another modification.

### DETAILED DESCRIPTION OF THE EMBODIMENTS

### First Embodiment

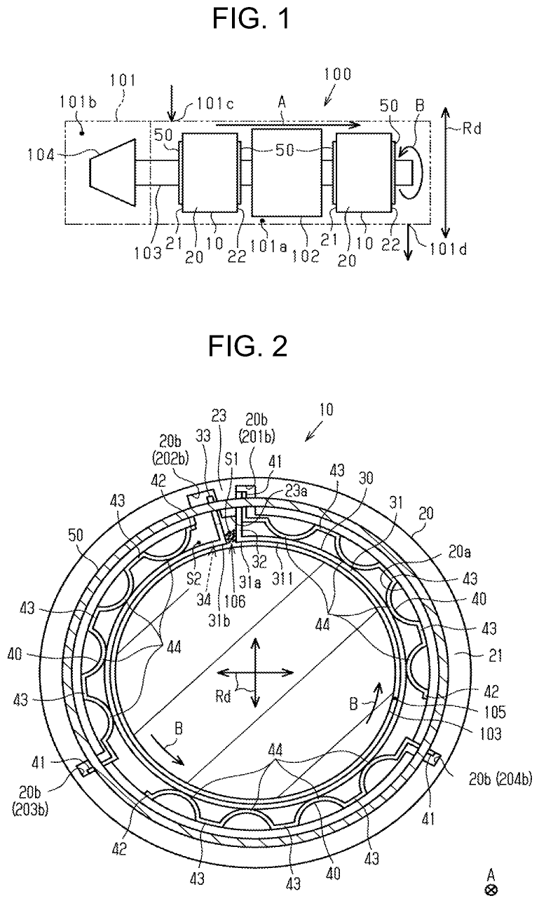

The following will describe a first embodiment of a centrifugal compressor serving as the fluid machine of the present disclosure, with reference to accompanying FIGS. 1 to 4.

<Centrifugal Compressor>

As illustrated in FIG. 1, a centrifugal compressor 100 includes a plurality of fluid dynamic plain bearings 10 (in this embodiment, two fluid dynamic plain bearings 10), a housing 101, a motor 102, a rotating member 103, and an impeller 104 serving as an operating member. The housing 101 accommodates the rotating member 103, the motor 102, the impeller 104, and the fluid dynamic plain bearings 10. The housing 101 has therein a motor chamber 101a in which the motor 102 is accommodated and an impeller chamber 101b in which the impeller 104 is accommodated. In this embodiment, a shaft serves as the rotating member 103. The rotating member 103 extends from the motor chamber 101a to the impeller chamber 101b. The rotating member 103 is provided with the motor 102. The rotating member 103 has an end provided with the impeller 104. The motor 102 is configured to rotate the rotating member 103. The rotation of the rotating member 103 rotates the impeller 104 integrally. The rotating member 103 is configured to rotate to drive the impeller 104. The rotation of the impeller 104 causes a fluid to flow from the outside of the housing 101 into the impeller chamber 101b. For example, air serves as the fluid of the present disclosure. The fluid flowed into the impeller chamber 101b is compressed with the rotation of the impeller 104. The compressed fluid leaks to the motor chamber 101a. The compressed fluid is discharged to the outside of the housing 101, for example, a fuel cell mounted on a vehicle.

The two fluid dynamic plain bearings 10 support the rotating member 103 in a radial direction Rd. The radial direction Rd corresponds to the radial direction of the rotating member 103. The fluid dynamic plain bearings 10 are disposed so that the fluid dynamic plain bearings 10 hold therebetween the motor 102 in the axial direction of the rotating member 103. The fluid dynamic plain bearings 10 are fixed to the housing 101. The fluid dynamic plain bearings 10 support the rotating member 103 such that the rotating member 103 is rotatable relative to the housing 101.

The housing 101 has an inlet 101c and an outlet 101d. The inlet 101c introduces air into the motor chamber 101a of the housing 101. The inlet 101c is located between one of the fluid dynamic plain bearings 10 and the impeller 104 in the axial direction of the rotating member 103. The outlet 101d discharges the air introduced into the motor chamber 101a to the outside of the housing 101. The other of the fluid dynamic plain bearings 10 is located between the outlet 101d and the motor 102 in the axial direction of the rotating member 103.

The air introduced through the inlet 101c flows in the axial direction of the rotating member 103 from the one of the fluid dynamic plain bearings 10 toward the other of the fluid dynamic plain bearings 10. The air introduced through the inlet 101c flows toward the outlet 101d in the motor chamber 101a. The air introduced into the motor chamber 101a flows through a gap between the fluid dynamic plain bearings 10 and the rotating member 103 to directly cool the fluid dynamic plain bearings 10. The motor chamber 101a serves as the cooling flow passage of the present disclosure in which the air flows. The air serves as the fluid of the present disclosure that directly cools the fluid dynamic plain bearings 10. The centrifugal compressor 100 has the motor chamber 101a that serves as the cooling flow passage. The air, which has been introduced into the motor chamber 101a through the inlet 101c, cools the one of the fluid dynamic plain bearings 10, the motor 102, and the other of the fluid dynamic plain bearings 10 in this order, and is discharged to the outside of the housing 101 through the outlet 101d. In the following description, the flow of the air from the inlet 101c toward the outlet 101d is expressed by the flow direction A.

<Fluid Dynamic Plain Bearing>

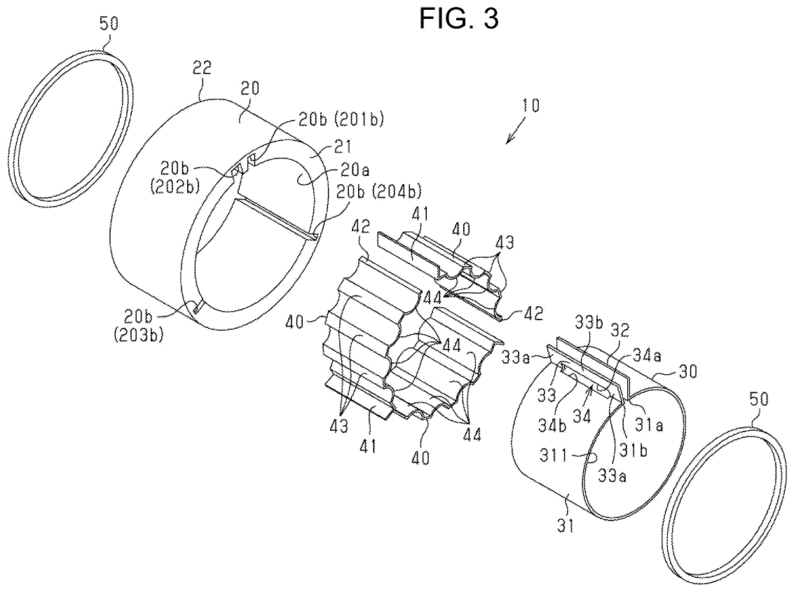

As illustrated in FIGS. 2 and 3, each fluid dynamic plain bearing 10 includes a bearing housing 20, a top foil 30 having a thin plate shape, a plurality of bump foils 40 (in this embodiment, three bump foils 40) having a thin plate shape, a plurality of regulating members 50 (in this embodiment, two regulating members 50).

<Bearing Housing>

As illustrated in FIG. 2, the bearing housing 20 is a cylindrical member through which the rotating member 103 is inserted. The bearing housing 20 is made of a material, such as aluminum. The bearing housing 20 has an inner peripheral surface 20a. The inner peripheral surface 20a is a cylindrical surface. The axial direction of the bearing housing 20 corresponds to the axial direction of the rotating member 103. The radial direction of the bearing housing 20 corresponds to the radial direction of the rotating member 103. The circumferential direction of the bearing housing 20 corresponds to the circumferential direction of the rotating member 103.

As illustrated in FIG. 3, the bearing housing 20 has a first end surface 21 and a second end surface 22. The first end surface 21 and the second end surface 22 have an annular shape. The first end surface 21 is a surface of one end of the bearing housing 20 in the axial direction. The second end surface 22 is a surface of the other end of the bearing housing 20 in the axial direction. As illustrated in FIG. 1, the first end surface 21 of the bearing housing 20 is located upstream in the flow direction A. The second end surface 22 of the bearing housing 20 is located downstream in the flow direction A.

As illustrated in FIGS. 2 and 3, the inner peripheral surface 20a of the bearing housing 20 has a plurality of grooves 20b. The plurality of grooves 20b, specifically, the four grooves 20b, are formed in the inner peripheral surface 20a. The grooves 20b extend in the axial direction of the bearing housing 20. The grooves 20b extend over whole of the bearing housing 20 in the axial direction of the bearing housing 20. The grooves 20b are opened on the first end surface 21 and the second end surface 22.

As illustrated in FIG. 2, the grooves 20b are composed of a first groove 201b, a second groove 202b, a third groove 203b, and a fourth groove 204b. The first groove 201b, the third groove 203b, and the fourth groove 204b are equally spaced from each other in the circumferential direction of the bearing housing 20. The third groove 203b is located in front of the first groove 201b in the rotation direction B of the rotating member 103. The fourth groove 204b is located in front of the third groove 203b in the rotation direction B. The first groove 201b is located in front of the fourth groove 204b in the rotation direction B.

The width of the first groove 201b is greater than the width of the third groove 203b and the width of the fourth groove 204b in the circumferential direction of the bearing housing 20. The width of the third groove 203b is the same as the width of the fourth groove 204b in the circumferential direction of the bearing housing 20.

The second groove 202b is located between the first groove 201b and the third groove 203b in the circumferential direction of the bearing housing 20. The distance between the first groove 201b and the second groove 202b is shorter than the distance between the second groove 202b and the third groove 203b in the circumferential direction of the bearing housing 20. The second groove 202b is closer to the first groove 201b than to the third groove 203b. The second groove 202b is adjacent to the first groove 201b in the circumferential direction of the bearing housing 20. The second groove 202b is located in front of the first groove 201b in the rotation direction B. The width of the second groove 202b is greater than the width of the first groove 201b in the circumferential direction of the bearing housing 20.

The bearing housing 20 has a wall portion 23 that is located between the first groove 201b and the second groove 202b. The wall portion 23 has a wall surface 23a that is a part of the inner peripheral surface 20a of the bearing housing 20. The wall surface 23a faces the rotating member 103.

<Top Foil>

The top foil 30 is disposed inside the bearing housing 20. The top foil 30 is formed of a flexible long metallic plate by curving the long metallic plate. The metallic plate forming the top foil 30 is made of nickel alloy, such as stainless steel or Inconel™.

The top foil 30 has a cylindrical portion 31. The cylindrical portion 31 is formed by curving a part of the long metallic plate forming the top foil 30 into a cylindrical shape. The cylindrical portion 31 is arranged between the rotating member 103 and the bearing housing 20. The cylindrical portion 31 is located between the rotating member 103 and the bump foils 40. The axial direction of the cylindrical portion 31 corresponds to the axial direction of the bearing housing 20. The radial direction of the cylindrical portion 31 corresponds to the radial direction of the bearing housing 20. The circumferential direction of the cylindrical portion 31 corresponds to the circumferential direction of the bearing housing 20. The cylindrical portion 31 is formed by curving the metallic plate forming the top foil 30 into a cylindrical shape such that the long edges and the short edges of the metallic plate respectively extend in the circumferential direction and the axial direction.

The cylindrical portion 31 has a bearing surface 311 that has a cylindrical shape. The bearing surface 311 faces the rotating member 103. The bearing surface 311 of the cylindrical portion 31 is coated with a coating material (not illustrated). The coating material protects the cylindrical portion 31 from the rotating member 103 when the cylindrical portion 31 comes in contact with the rotating member 103.

The bearing surface 311 has one end portion 31a in the circumferential direction of the bearing surface 311, and the top foil 30 has a fixed end 32 formed at the one end portion 31a of the bearing surface 311. The metallic plate forming the top foil 30 has one end and the other end in the long edge direction of the metallic plate, and the fixed end 32 is formed by bending the one end of the metallic plate in the radially outward direction of the cylindrical portion 31. The fixed end 32 extends from the one end portion 31a of the bearing surface 311 toward the bearing housing 20. The fixed end 32 extends in the axial direction of the bearing housing 20. The fixed end 32 extends straight in the axial direction of the rotating member 103. The fixed end 32 is inserted into the first groove 201b.

The bearing surface 311 has the other end portion 31b in the circumferential direction of the bearing surface 311, and the top foil 30 has a free end 33 formed at the other end portion 31b of the bearing surface 311. The free end 33 is formed by bending the other end of the metallic plate in the radially outward direction of the cylindrical portion 31. The free end 33 extends from the other end portion 31b toward the bearing housing 20. The free end 33 extends in the axial direction of the bearing housing 20. The free end 33 extends straight in the axial direction of the rotating member 103. The free end 33 is inserted into the second groove 202b. The free end 33 faces the fixed end 32 in the circumferential direction of the cylindrical portion 31. The free end 33 is separated from the fixed end 32 in the circumferential direction of the cylindrical portion 31.

A clearance S1 is formed between the fixed end 32 and the free end 33. The clearance S1 is a space surrounded by the fixed end 32, the free end 33, and the wall surface 23a of the bearing housing 20. The air in the motor chamber 101a flows through the clearance S1.

<Bump Foil>

The three bump foils 40 are arranged on the opposite side of the top foil 30 from the rotating member 103. The bump foils 40 are arranged between the inner peripheral surface 20a of the bearing housing 20 and the cylindrical portion 31 of the top foil 30. The bump foils 40 are spaced from each other at a predetermined distance in the circumferential direction of the bearing housing 20. Each of the bump foils 40 is formed of a flexible long metallic plate curved into an approximately arc shape. The short edge direction of the bump foil 40 corresponds to the axial direction of the bearing housing 20. The metallic plate forming the bump foil 40 is made of nickel alloy, such as stainless steel or Inconel™.

The bump foil 40 has a fixed end 41 and a free end 42. The fixed end 41 is one end of the bump foil 40 in the long edge direction of the metallic plate forming the bump foil 40. The fixed ends 41 of the bump foils 40 are respectively inserted into the first groove 201b, the third groove 203b, and the fourth groove 204b. One of the fixed ends 41 is inserted, together with the fixed end 32 of the top foil 30, into the first groove 201b. The free end 42 is the other end of the bump foil 40 in the long edge direction of the metallic plate forming the bump foil 40. The free end 42 of one bump foil 40 is spaced from the fixed end 41 of another bump foil 40 adjacent to the one bump foil 40 at a predetermined distance in the circumferential direction of the bearing housing 20.

Each bump foil 40 has a plurality of depressions 43 that are in contact with the inner peripheral surface 20a of the bearing housing 20. The depressions 43 extend along the inner peripheral surface 20a of the bearing housing 20. The bump foil 40 further has a plurality of projections 44 in contact with the cylindrical portion 31. The projections 44 project so as to become distant from the inner peripheral surface 20a of the bearing housing 20. The bump foil 40 has a corrugated shape in which the depressions 43 and the projections 44 are alternately arranged in the circumferential direction of the bearing housing 20. In the bump foil 40, the depressions 43 and the projections 44 are alternately arranged from the fixed end 41 toward the free end 42. The projections 44 have an arc shape so as to have a spring structure. The peak of each projection 44 is in contact with the cylindrical portion 31. The projection 44 becomes elastically deformed so as to extend in the circumferential direction of the bearing housing 20 when the top foil 30 becomes elastically deformed in the radially outward direction. This allows the bump foil 40 to extend in the circumferential direction of the bearing housing 20 to elastically support the top foil 30.

<Regulating Member>

The regulating members 50 have a circular ring shape. The inner diameter of each regulating member 50 is greater than the inner diameter of the bearing housing 20. The outer diameter of the regulating member 50 is smaller than the outer diameter of the bearing housing 20. As illustrated in FIG. 1, in the axial direction of the bearing housing 20, one and the other regulating members 50 are respectively fixed to the first end surface 21 and the second end surface 22 of the bearing housing 20.

As illustrated in FIG. 2, each regulating member 50 overlaps the grooves 20b in the axial direction of the bearing housing 20. The regulating member 50 faces the fixed end 32 and the free end 33 of the top foil 30 in the axial direction of the rotating member 103. The regulating member 50 faces the fixed end 41 of the bump foil 40 in the axial direction of the rotating member 103.

As illustrated in FIGS. 1 and 2, the regulating members 50 hold therebetween the fixed end 32 and the free end 33 partly in the axial direction of the bearing housing 20. The regulating members 50 hold therebetween the fixed end 41 of the bump foil 40 in the axial direction of the bearing housing 20. Accordingly, the regulating members 50 regulate the movement of the fixed end 32, the fixed end 41, and the free end 33 in the axial direction of the rotating member 103. The regulating members 50 prevent the top foil 30 and the bump foil 40 from falling from the bearing housing 20. The regulating members 50 suppress deformation of the top foil 30. The regulating members 50 allow the bearing housing 20 to support the top foil 30 and the bump foil 40.

<Top Foil and Bump Foil while Fluid Machine is Driven>

As illustrated in FIG. 2, the rotating member 103 rotates in the rotation direction B when the centrifugal compressor 100 is driven. This causes air to flow into a gap between the rotating member 103 and the cylindrical portion 31 of the top foil 30. In the gap between the rotating member 103 and the cylindrical portion 31, the air flows in the rotation direction B. The flow of the air presses the fixed end 32 of the top foil 30 against the most front part of the inner surface of the first groove 201b in the rotation direction B. Accordingly, the most front part of the inner surface of the first groove 201b in the rotation direction B regulates the movement of the fixed end 32 during the rotation of the rotating member 103. The fixed end 32 is held by the bearing housing 20. This configuration regulates the rotation of the top foil 30 in the bearing housing 20. The width of the first groove 201b in the circumferential direction of the bearing housing 20 is determined in consideration that the fixed end 32 comes in contact with the most front part of the inner surface of the first groove 201b in the rotation direction B during the rotation of the rotating member 103 in the rotation direction B.

When the rotational speed of the rotating member 103 reaches a predetermined rotational speed, the air, which has been flowed into the gap between the rotating member 103 and the cylindrical portion 31 of the top foil 30, forms a fluid film 105. The dynamic pressure of the fluid film 105 allows the rotating member 103 to float off the top foil 30. The fluid film 105 allows the rotating member 103 to be supported by the top foil 30 in the radial direction Rd without being in contact with the top foil 30.

The fluid film 105, which is formed with the rotation of the rotating member 103, causes the cylindrical portion 31 of the top foil 30 to become elastically deformed and bulge in the radially outward direction of the bearing housing 20. In this situation, the free end 33 of the top foil 30 moves in the second groove 202b in the rotation direction B. The free end 33 does not come in contact with the inner surface of the second groove 202b even through the cylindrical portion 31 becomes elastically deformed. Accordingly, the movement of the free end 33 in the second groove 202b in the rotation direction B is not regulated when the cylindrical portion 31 becomes elastically deformed. This allows the elastic deformation of the cylindrical portion 31. The width of the second groove 202b in the circumferential direction of the bearing housing 20 is determined in consideration that the free end 33 does not come in contact with the inner surface of the second groove 202b during the rotation of the rotating member 103 in the rotation direction B.

The elastic deformation of the cylindrical portion 31 of the top foil 30 causes the projections 44 of the bump foil 40 to be subjected to a load applied by the cylindrical portion 31. The load applied by the cylindrical portion 31 of the top foil 30 causes the projections 44 to become elastically deformed so that the projections 44 extend in the circumferential direction of the bearing housing 20, and the top foil 30 is elastically supported by the bump foil 40.

<Discharge Passage>

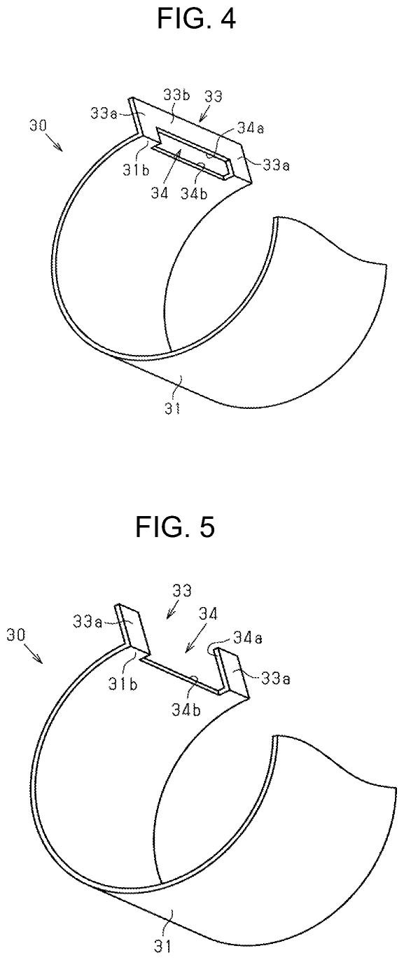

As illustrated in FIG. 4, the free end 33 of the top foil 30 has a discharge passage 34 formed through the free end 33. The discharge passage 34 is formed through the metallic plate forming the top foil 30 in the thickness direction of the metallic plate. The discharge passage 34 serves as the through hole of the present disclosure that is formed through the free end 33.

As indicated by a broken line in FIG. 2, a clearance S1 is in communication, through the discharge passage 34, with a space S2 formed between the cylindrical portion 31 and the bearing housing 20. The space S2 is a space facing the second groove 202b in the radial direction of the rotating member 103.

As illustrated in FIG. 4, the discharge passage 34 includes a first portion 34a and a second portion 34b. The first portion 34a of the discharge passage 34 is formed through a part of the free end 33 of the top foil 30 in the thickness direction of the free end 33. The free end 33 has a pair of axial end portions 33a and a connecting portion 33b. The axial end portions 33a are end portions of the free end 33 in the axial direction of the cylindrical portion 31. Each of the axial end portions 33a includes a part of the corresponding long edge of the metallic plate forming the top foil 30. Each of the axial end portions 33a includes a part of the corresponding short edge of the metallic plate forming the top foil 30.

As illustrated in FIG. 3, one and the other of the axial end portions 33a face the one and the other of the regulating members 50, respectively. The one of the axial end portions 33a comes in contact with the one of the regulating members 50 when the free end 33 moves in the axial direction of the rotating member 103.

As illustrated in FIG. 4, the connecting portion 33b connects the axial end portions 33a. The connecting portion 33b includes a part of the corresponding short edge of the metallic plate forming the top foil 30. The connecting portion 33b cooperates with the axial end portions 33a to form the corresponding short edge of the metallic plate forming the top foil 30. The first portion 34a of the discharge passage 34 is surrounded by the axial end portions 33a and the connecting portion 33b.

The second portion 34b of the discharge passage 34 is formed through a part of the cylindrical portion 31 in the thickness direction of the cylindrical portion 31. The second portion 34b is in communication with the first portion 34a. The second portion 34b is formed by cutting a part of the other end portion 31b of the bearing surface 311. The border between the other end portion 31b of the bearing surface 311 and the free end 33 is bent. Accordingly, the discharge passage 34 includes a bending portion, which is the border between the cylindrical portion 31 and the free end 33. That is, the discharge passage 34 extends from the free end 33 to the bearing surface 311. The second portion 34b is formed by cutting a part of the cylindrical portion 31 so as to sufficiently form the fluid film 105 that supports the rotating member 103. For the sake of explanation, the fixed end 32 is not illustrated in FIG. 4.

[Operation of First Embodiment]

The following will describe the operation according to the first embodiment. When the rotational speed of the rotating member 103 reaches the predetermined rotational speed, the rotating member 103 is supported by the fluid film 105 in the radial direction Rd. This configuration allows the regulating members 50 to regulate the movement of the fixed end 32 and the free end 33 of the top foil 30 in the axial direction of the rotating member 103 even if the top foil 30 moves in the axial direction of the bearing housing 20. Accordingly, the top foil 30 is unlikely to become deformed. This prevents the rotating member 103 from coming in contact with only a part of the bearing surface 311. This therefore reduces uneven wear of the rotating member 103 and the top foil 30.

If the rotating member 103 rotates while being in contact with the cylindrical portion 31 of the top foil 30, abrasion powders may be produced. The abrasion powders may be produced, for example, by wear of the coating material on the bearing surface 311, wear of the outer peripheral surface of the rotating member 103, or wear of the bearing surface 311 itself. In addition, dusts may enter, with the air, the clearance between fixed end 32 and the free end 33. That is, as illustrated in FIG. 2, the foreign substance 106, such as abrasion powders or dusts, may enter the clearance S1, together with the air.

According to the first embodiment, even if the foreign substance 106 enters the clearance S1, the foreign substance 106 is discharged to the space S2 from the clearance S1 through the discharge passage 34 indicated by the broken line in FIG. 2. This reduces deposition of the foreign substance 106 in the clearance between the fixed end 32 and the free end 33.

Reducing the deposition of the foreign substance 106 in the clearance between the fixed end 32 and the free end 33 prevents the foreign substance 106 from projecting toward the rotating member 103 through the clearance between the fixed end 32 and the free end 33, thereby preventing the foreign substance 106 from pressing the rotating member 103. This prevents that pressing the rotating member 103 by the foreign substance 106 increases a pressure that causes the rotating member 103 to come in contact with the bearing surface 311 of the top foil 30. Accordingly, the foreign substance 106 is unlikely to flow from the clearance between the fixed end 32 and the free end 33 into the gap between the rotating member 103 and the cylindrical portion 31. This prevents an increase in the pressure that causes the rotating member 103 to come in contact with the bearing surface 311 of the top foil 30. Accordingly, the foreign substance 106 does not increase the pressure that causes the rotating member 103 to come in contact with the top foil 30. This reduces wear of the top foil 30, thereby curbing a decline in the durability of the fluid dynamic plain bearing 10.

[Advantageous Effects of First Embodiment]

The following will describe the advantageous effects according to the first embodiment.

(1-1) The free end 33 has the discharge passage 34 formed through the free end 33. This configuration allows the foreign substance 106 to be discharged from the clearance S1 through the discharge passage 34 even if the foreign substance 106 enters the clearance S1. This therefore prevents the foreign substance 106 from being deposited in the clearance between the fixed end 32 and the free end 33, thereby curbing a decline in the durability of the fluid dynamic plain bearing 10.

(1-2) The discharge passage 34 is formed of a through hole of the present disclosure that is formed through the free end 33 of the top foil 30. This configuration allows the free end 33 to have the discharge passage 34 with the edge of the free end 33 of the top foil 30 maintained. This maintains the strength of the free end 33, while allowing the free end 33 to have the discharge passage 34. This therefore suppresses the deformation of the free end 33 when the regulating member 50 regulates the movement of the free end 33 in the axial direction of the rotating member 103.

(1-3) The discharge passage 34 extends to the bearing surface 311. This configuration facilitates the discharge of the foreign substance 106, which flows in the gap between the rotating member 103 and the bearing surface 311 of the top foil 30, from the clearance S1 through the discharge passage 34. This therefore further prevents the foreign substance 106 from being deposited in the clearance between the fixed end 32 and the free end 33. Additionally, this configuration facilitates bending of the free end 33.

(1-4) The fixed end 32 and the free end 33 of the top foil 30 are inserted in the first groove 201b and the second groove 202b, respectively. The first groove 201b and the second groove 202b mark the positions at which the fixed end 32 and the free end 33 are arranged. This allows the top foil 30 to be easily arranged in the bearing housing 20.

### Second Embodiment

The following will describe a fluid machine according to a second embodiment with reference to accompanying FIG. 5. The second embodiment is different from the first embodiment in the configuration of the discharge passage. The following will describe the difference between the first embodiment and the second embodiment. The elements of the second embodiment same as those of the first embodiment are denoted by the identical numbers, and a detailed explanation is not elaborated.

<Discharge Passage>

As illustrated in FIG. 5, the free end 33 of the top foil 30 consists of the pair of axial end portions 33a without the connecting portion 33b. The first portion 34a of the discharge passage 34 is opened on the edge of the free end 33 in the long edge direction of the metallic plate forming the top foil 30. The discharge passage 34 is formed by cutting a part of the free end 33 in the long edge direction of the metallic plate forming the top foil 30. In the second embodiment, the discharge passage 34 extends to the bearing surface 311. For the sake of explanation, the fixed end 32 is not illustrated in FIG. 5.

[Operation and Advantageous Effects of Second Embodiment]

The second embodiment provides following operation and advantageous effects in addition to the operation and advantageous effects mentioned in (1-1), (1-3), and (1-4) of the first embodiment.

(2-1) The discharge passage 34 is formed by cutting a part of the free end 33. This allows the discharge passage 34 to extend to the edge of the free end 33 of the top foil 30. This secures the size of the discharge passage 34, thereby facilitating the discharge of the foreign substance 106 from the clearance S1 through the discharge passage 34.

### Third Embodiment

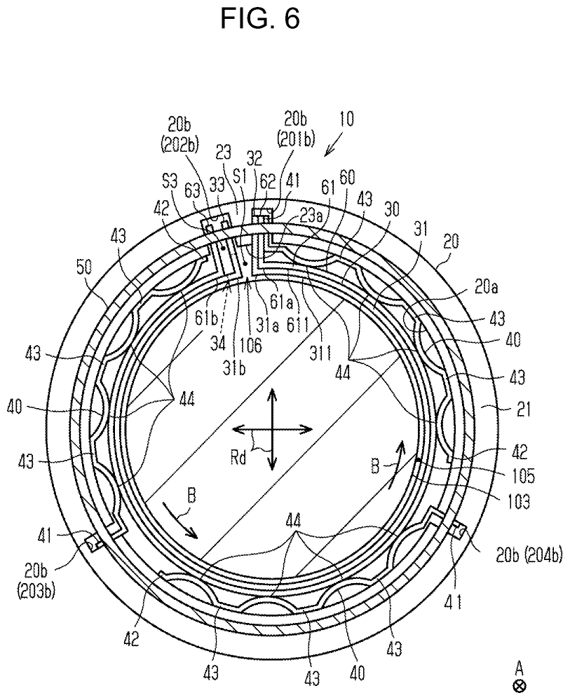

The following will describe a fluid machine according to a third embodiment with reference to accompanying FIG. 6. The third embodiment is different from the first embodiment in an additional element. The following will describe the difference between the first embodiment and the third embodiment. The elements of the third embodiment same as those of the first embodiment are denoted by the identical numbers, and a detailed explanation is not elaborated.

<Guide Foil>

As illustrated in FIG. 6, a guide foil 60 is disposed between the top foil 30 and the bump foils 40. The guide foil 60 has a shape that is the same as the shape of the top foil 30. The guide foil 60 is made of a material that is the same as the material of the top foil 30.

The guide foil 60 has a cylindrical portion 61. The cylindrical portion 61 is located between the top foil 30 and the bump foils 40. The cylindrical portion 61 has a covering surface 611 that has a cylindrical shape. The covering surface 611 faces the cylindrical portion 31 of the top foil 30. The covering surface 611 covers the top foil 30. The guide foil 60 is in contact with the projections 44 of the bump foils 40. Accordingly, the bump foils 40 elastically support the top foil 30 via the guide foil 60.

The covering surface 611 has one end portion 61a and the other end portion 61b in the circumferential direction of the covering surface 611, and the guide foil 60 has a fixed end 62 formed at the one end portion 61a of the covering surface 611. The fixed end 62 extends from the one end portion 61a toward the bearing housing 20. The fixed end 62 is inserted into the first groove 201b. The fixed end 62 extends straight in the axial direction of the rotating member 103. The fixed end 62 is disposed between the fixed end 32 of the top foil 30 and the fixed end 41 of the corresponding bump foil 40.

The covering surface 611 has the other end portion 61b in the circumferential direction of the covering surface 611, and the guide foil 60 has a free end 63 formed at the other end portion 61b of the covering surface 611. The free end 63 extends from the other end portion 61b toward the bearing housing 20. The free end 63 is inserted into the second groove 202b. The free end 63 extends straight in the axial direction of the rotating member 103. The free end 63 is located between the free end 33 of the top foil 30 and the free end 42 of the corresponding bump foil 40 in the circumferential direction of the bearing housing 20. The other end portion 61b of the covering surface 611 is disposed between the free end 33 of the top foil 30 and the corresponding bump foil 40. The covering surface 611 is disposed between the free end 33 and the corresponding bump foil 40.

The free end 63 faces the free end 33 of the top foil 30 in the circumferential direction of the bearing housing 20. The free end 63 is separated from the free end 33 of the top foil 30 in the circumferential direction of the bearing housing 20. A guide passage S3 is formed between the free end 33 of the top foil 30 and the free end 63 of the guide foil 60. The air in the motor chamber 101a flows through the guide passage S3. The foreign substance 106 discharged from the clearance S1 through the discharge passage 34 flows into the guide passage S3. The foreign substance 106 in the guide passage S3 flows with the air along the free end 63 of the guide foil 60. The free end 63 serves as the guide wall of the present disclosure that guides the foreign substance 106 discharged from the discharge passage 34. The guide passage S3 guides the foreign substance 106 discharged from the discharge passage 34.

[Operation and Advantageous Effects of Third Embodiment]

The third embodiment provides the following operation and advantageous effects in addition to the operation and advantageous effects of the first embodiment.

(3-1) The foreign substance 106 discharged from the clearance S1 through the discharge passage 34 flows into the guide passage S3. The foreign substance 106 in the guide passage S3 is guided by the free end 63 of the guide foil 60 to be discharged to the outside of the bearing housing 20. Accordingly, the foreign substance 106 discharged from the clearance S1 through the discharge passage 34 is unlikely to flow toward the bump foil 40. The foreign substance 106 is held between the bump foil 40 and the top foil 30. This interrupts wear progress of the bump foil 40 and the top foil 30 compared with the fluid dynamic plain bearing 10 provided without the guide foil 60. This therefore further curbs a decline in the durability of the fluid dynamic plain bearing 10.

(3-2) The foreign substance 106 discharged from the clearance S1 through the discharge passage 34 flows into the guide passage S3. The foreign substance 106 in the guide passage S3 is guided by the free end 63 of the guide foil 60 to be discharged to the outside of the bearing housing 20. Accordingly, the foreign substance 106 discharged from the clearance S1 through the discharge passage 34 is unlikely to flow toward the bump foil 40. The foreign substance 106 is held between the bump foil 40 and the bearing housing 20. This further interrupts wear progress of the bump foil 40 and the top foil 30 compared with the fluid dynamic plain bearing 10 provided without the guide foil 60. This therefore further curbs a decline in the durability of the fluid dynamic plain bearing 10.

(3-3) The guide foil 60 is disposed between the top foil 30 and the bump foils 40. In the fluid dynamic plain bearing 10 according to the third embodiment, the guide foil 60 is in contact with the bump foils 40, and the guide foil 60 is also in contact with the top foil 30. In the fluid dynamic plain bearing 10 provided without the guide foil 60, simply the top foil 30 and the bump foils 40 are in contact with each other. That is, the fluid dynamic plain bearing 10 according to the third embodiment supports the rotating member 103 at more positions compared with the fluid dynamic plain bearing 10 provided without the guide foil 60. This configuration allows the fluid dynamic plain bearing 10 to further dampen the vibration of the rotating member 103, thereby stabilizing the behavior of the rotating member 103.

(3-4) The presence of the guide foil 60 disposed between the top foil 30 and the bump foils 40 reduces flexure of the top foil 30. This curbs a decline in the load carrying capacity of the fluid dynamic plain bearing 10.

[Modifications]

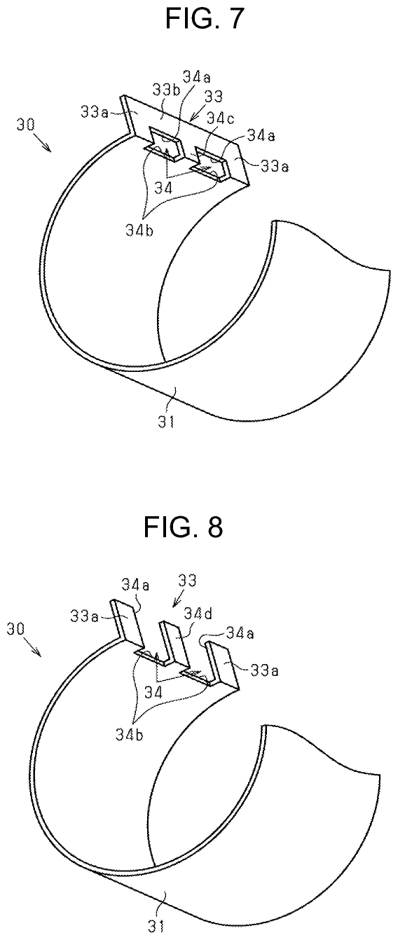

The embodiments may be modified as below. The embodiments may be combined with the following modifications within a technically consistent range.
In the first embodiment, the discharge passage 34 may be modified as illustrated in FIG. 7. For the sake of explanation, the fixed end 32 is not illustrated in FIG. 7.

As illustrated in FIG. 7, the free end 33 of the top foil 30 may have two discharge passages 34 formed through the free end 33. The top foil 30 may further include a single first partition 34c. The first partition 34c is disposed separating the two discharge passages 34. The first partition 34c connects the cylindrical portion 31 and the connecting portion 33b. The number of the discharge passages 34 may be determined as appropriate.
In the second embodiment, the discharge passage 34 may be modified as illustrated in FIG. 8. For the sake of explanation, the fixed end 32 is not illustrated in FIG. 8.

As illustrated in FIG. 8, the free end 33 of the top foil 30 may have two discharge passages 34 formed through the free end 33. The top foil 30 may further include a single second partition 34d. The second partition 34d is disposed separating the two discharge passages 34. In the long edge direction of the metallic plate forming the top foil 30, the edge of the second partition 34d is a part of the corresponding short edge of the metallic plate forming the top foil 30. The number of the discharge passages 34 may be determined as appropriate.
According to the embodiments, the one and the other of the regulating members 50 are fixed to the first end surface 21 and the second end surface 22 of the bearing housing 20, respectively, but the present invention is not limited thereto. For example, the regulating members 50 may be fixed to the inner peripheral surface 20a of the bearing housing 20. The regulating members 50 have to face the fixed end 32 and the free end 33 in the axial direction of the rotating member 103 to regulate the movement of the fixed end 32 and the free end 33 in the axial direction of the rotating member 103.
In the embodiments, the regulating members 50 need not have a circular ring shape. For example, the regulating members 50 may have a square shape so as to be fitted in the grooves 20b.
In the embodiments, the free end 33 of the top foil 30 does not have to be inserted into the second groove 202b. In this configuration, the inner peripheral surface 20a of the bearing housing 20 is provided without the second groove 202b, and the regulating members 50 are fixed to the inner peripheral surface 20a of the bearing housing 20. The free end 33 has to face the regulating members 50 in the axial direction of the rotating member 103.
In the embodiments, the fixed end 32 of the top foil 30 may be fixed to the inner surface of the first groove 201b. Furthermore, the fixed end 32 of the top foil 30 does not have to be inserted into the first groove 201b. In this configuration, the inner peripheral surface 20a of the bearing housing 20 may be provided without the first groove 201b, and the fixed end 32 may be fixed to the inner peripheral surface 20a of the bearing housing 20. That is, the fixed end 32 has to cause the top foil 30 to be held by the bearing housing 20 at least during the rotation of the rotating member 103.
In the embodiments, one of the two regulating members 50 may be eliminated. In this configuration, openings of the grooves 20b on the first end surface 21 or the second end surface 22 are preferably closed. The openings of the grooves 20b closed in the axial direction of the rotating member 103 may face the fixed end 32 and the free end 33 in the axial direction of the rotating member 103 to prevent the top foil 30 from falling from the bearing housing 20. That is, for example, the bearing housing 20 or the housing 101 may serve as the regulating member to regulate the movement of the free end 33 in the axial direction of the rotating member 103.
In the embodiments, the regulating members 50 need not constitute the fluid dynamic plain bearing 10. In this configuration, the top foil 30 and the bump foils 40 may be modified so that the top foil 30 and the bump foils 40 are supported by the bearing housing 20 as appropriate.
In the embodiments, the discharge passage(s) 34 may include the first portion 34a only without the second portion 34b. That is, the discharge passage(s) 34 does not have to extend to the bearing surface 311.
In the embodiments, the shape of the discharge passage(s) 34 may be modified as appropriate. The discharge passage(s) 34 has to be formed through the free end 33 so that the foreign substance 106 is discharged from the clearance S1.
In the embodiments, the fluid dynamic plain bearing 10 includes three bump foils 40, but the fluid dynamic plain bearing 10 may include a single bump foil 40 having an approximately cylindrical shape. The number of the bump foils 40 is determined such that the bump foils 40 elastically support the top foil 30 appropriately.
In the embodiments, refrigerant serves as the fluid of the present disclosure that flows in the motor chamber 101a and directly cools the fluid dynamic plain bearing 10.
In the embodiments, the centrifugal compressor 100 may include a single fluid dynamic plain bearing 10, or three or more fluid dynamic plain bearings 10.

### NOTES

The following will describe technical ideas of the embodiments and the modifications.

[1] A fluid machine comprising: an operating member; a rotating member configured to rotate to drive the operating member; a housing for accommodating the operating member and the rotating member; a plurality of fluid dynamic plain bearings supporting the rotating member such that the rotating member is rotatable relative to the housing; and a cooling flow passage which is formed in the housing and in which a fluid flows through a gap between the rotating member and the fluid dynamic plain bearings to directly cool the fluid dynamic plain bearings, the fluid dynamic plain bearings each including: a top foil facing the rotating member, and having a bearing surface that has a cylindrical shape and one end portion and the other end portion in a circumferential direction of the bearing surface; a bump foil having a thin plate shape, arranged on the opposite side of the top foil from the rotating member, and configured to extend to elastically support the top foil; and a bearing housing supporting the top foil and the bump foil, the top foil having a fixed end and a free end respectively formed at the one end portion and the other end portion of the bearing surface of the top foil, the fixed end extending toward and being held by the bearing housing, the free end extending toward the bearing housing, a movement of the free end of the top foil in an axial direction of the rotating member being regulated by a regulating member, and a clearance through which the fluid flows being formed between the fixed end and the free end, wherein the free end has a discharge passage through which a foreign substance contained in the fluid is discharged from the clearance, the discharge passage being formed through the free end.

[2] The fluid machine according to [1], wherein the discharge passage is formed of a through hole that is formed through the free end.

[3] The fluid machine according to [1], wherein the discharge passage is formed by cutting a part of the free end.

[4] The fluid machine according to [2] or [3], wherein the discharge passage extends to the bearing surface.

[5] The fluid machine according to any one of [1] to [4], wherein a guide foil is disposed between the top foil and the bump foil, the guide foil has a covering surface that has a cylindrical shape, covers the top foil, and is disposed between the free end of the top foil and the bump foil, the guide foil has a guide wall that is formed at an end portion of the covering surface disposed between the free end of the top foil and the bump foil, extends toward the bearing housing, and guides the foreign substance discharged through the discharge passage, and a guide passage for guiding the foreign substance is formed between the free end of the top foil and the guide wall of the guide foil.

What is claimed is:

1. A fluid machine comprising:
an operating member;
a rotating member configured to rotate to drive the operating member;
a housing for accommodating the operating member and the rotating member;
a plurality of fluid dynamic plain bearings supporting the rotating member such that the rotating member is rotatable relative to the housing; and
a cooling flow passage which is formed in the housing and in which a fluid flows through a gap between the rotating member and the fluid dynamic plain bearings to directly cool the fluid dynamic plain bearings, the fluid dynamic plain bearings each including:
a top foil facing the rotating member, and having a bearing surface that has a cylindrical shape and one end portion and the other end portion in a circumferential direction of the bearing surface;
a bump foil having a thin plate shape, arranged on the opposite side of the top foil from the rotating member, and configured to extend to elastically support the top foil; and
a bearing housing supporting the top foil and the bump foil,
the top foil having a fixed end and a free end respectively formed at the one end portion and the other end portion of the bearing surface of the top foil, the fixed end extending toward and being held by the bearing housing, the free end extending toward the bearing housing,
a movement of the free end of the top foil in an axial direction of the rotating member being regulated by a regulating member, and
a clearance through which the fluid flows being formed between the fixed end and the free end,
wherein the free end has a discharge passage through which a foreign substance contained in the fluid is discharged from the clearance, the discharge passage being formed through the free end.

2. The fluid machine according to claim 1, wherein the discharge passage is formed of a through hole that is formed through the free end.

3. The fluid machine according to claim 1, wherein the discharge passage is formed by cutting a part of the free end.

4. The fluid machine according to claim 2, wherein the discharge passage extends to the bearing surface.

5. The fluid machine according to claim 1, wherein
a guide foil is disposed between the top foil and the bump foil,
the guide foil has a covering surface that has a cylindrical shape, covers the top foil, and is disposed between the free end of the top foil and the bump foil,
the guide foil has a guide wall that is formed at an end portion of the covering surface disposed between the free end of the top foil and the bump foil, extends toward the bearing housing, and guides the foreign substance discharged through the discharge passage, and
a guide passage for guiding the foreign substance is formed between the free end of the top foil and the guide wall of the guide foil.
